(19) United States
(12) Patent Application Publication
(10) Pub. No.: US 2009/0210427 A1
(43) Pub. Date: Aug. 20, 2009

(54) Secure Business Continuity and Disaster Recovery Platform for Multiple Protected Systems

(76) Inventors: Chris Eidler, Danville, CA (US); Bryan Davis, San Francisco, CA (US); William Turner, San Ramon, CA (US)

Correspondence Address: HICKMAN PALERMO TRUONG & BECKER, LLP, 2055 GATEWAY PLACE, SUITE 550, SAN JOSE, CA, 95110, US

(21) Appl. No.: 12/032,491

(22) Filed: Feb. 15, 2008

(51) Int. Cl. G06F 17/30; G06F 12/00

(52) U.S. Cl. 707/10; 707/204; 707/E17.001; 707/E17.008

(57) ABSTRACT

A data processing system, comprising a plurality of customer premises equipment (CPE) servers located at a plurality of different active sites, each of the CPE servers comprising a local storage unit, wherein each of the CPE servers is configured to collect one or more copies of one or more servers, applications or data of the active site at which that CPE server is located and to store the copies in the local storage unit of that CPE server; a data storage and compute unit that is coupled to the CPE servers through a network, wherein the data storage unit is configured to receive transmissions of the copies, to verify the copies, and to store the copies in online accessible secure storage that is segregated by business entity; logic stored in a computer-readable storage medium and coupled to the data storage unit and to the CPE servers through the network, wherein the logic is operable to receive a request from a particular active site to restore one or more data elements contained in the secure storage of the data storage unit associated with the particular active site, to inflate the one or more data elements, and to provide the particular active site with online access to the one or more data elements that are inflated.

### FIELD OF THE INVENTION

The present disclosure relates to business continuity systems and disaster recovery systems that are used to protect computer software servers and applications.

### BACKGROUND

The dependence of institutions on continuous availability of computer systems and stored data mandates the use of a disaster recovery system. Unfortunately, past ways to address business continuity and disaster recovery have had serious shortcomings. In the past, disaster recovery systems have addressed only individual parts of an enterprise's complete computer environment. For example, a disaster recovery system might protect a particular firewall, or a router, or data, but not everything at once. Typically, the approach has been to provide individual fault-tolerant devices in an enterprise. Alternatively, companies have provided packaged software or other means to back up a single hardware unit or a single software element offsite; examples have included Mozy, Digital Island and Exodus (now Cable & Wireless). Managed firewall services have been available, but that approach only addresses security management and is not a complete disaster recovery solution. Monitoring network health of connections and servers and vulnerability scanning has been possible using products from Counterpane, Fishnet, etc.

However, past approaches have been unable to provide a consolidated set of servers and data that are available offsite for activation in the event of a disaster and none have provided a managed service.

Prior approaches also have not provided a platform that can scale to offer varying levels of service, operations, and technical feature sets given different customer needs with respect to cost, timeline for recovery, geographical location, etc.

Past approaches also include custom service engagements by firms such as SunGard, Hewlett-Packard, and IBM Global Services. These engagements are typically extremely costly and impractical for small businesses or medium-sized enterprises. Generally such custom engagements require the involvement of persons who are expert in many different information technology sub-specialties. FusionStorm has provided offsite leased servers and maintenance services, but its installations typically are not customizable by a customer and do not represent a backup of servers, applications or data that separately operate at the customer's site.

These approaches usually assume that the customer has existing staff and datacenter infrastructure which can be leveraged in the implementation of the limited solution. Multi-tenanting—that is, having one system serve multiple customers—is not considered nor enabled in the current state of the art.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### SUMMARY

In an embodiment, a data processing system comprises one or more data storage and compute units that are configured to be coupled to a plurality of active sites, wherein each of the data storage and compute unit is configured to cause collection of one or more copies of one or more servers, applications or data of the active sites and to cause storing the copies in on-site storage of the active sites, wherein each of the data storage and compute units is configured to receive transmissions of the copies of the servers, applications and data, to verify the copies, and to store the copies in online accessible secure storage that is segregated by business entity associated with each of the active sites; logic stored in a computer-readable storage medium and coupled to the data storage and compute units, wherein the logic is operable to receive a request from a particular active site to restore one or more data elements contained in the secure storage of the data storage and compute unit associated with the particular active site, to inflate the one or more data elements, and to provide the particular active site with online access to the one or more data elements that are inflated.

In an embodiment, the data elements comprise virtual machine images of the servers, applications and data. In an embodiment, the data elements comprise any of files, tables, and messages within any of the copies of servers, applications and data that are stored in the secure online accessible storage. In an embodiment, the logic comprises one or more glueware modules that implement the functions of collection, storing, verification, restoring, activating, and providing in cooperation with one or more stackware modules that implement low-level logical functions in communication with lower-level hardware and software elements and that are configured for modification in response to changes in the lower-level hardware and software elements without affecting the functions of the glueware.

In an embodiment, the logic further comprises a management interface operable to display information about all the copies of the servers, applications and data that are stored in the secure online accessible storage for all of the active sites, and the management interface is configured with functions to manage the particular active site, a particular one of the business entities, and all the active sites.

In an embodiment, the logic is further operable to copy the one or more data elements to a recovery site that is identified in the request, to inflate the one or more data elements at the recovery site, and to provide the particular active site with access to the one or more data elements that are inflated. In an embodiment, each of the data storage and compute units is configured to receive transmissions of the copies of the servers, applications and data, to store the copies in a demilitarized zone (DMZ) storage tier, to verify the copies in the DMZ storage tier, and to store the copies in the online accessible secure storage that is segregated by business entity.

In an embodiment, each of the one or more data centers comprises a datacenter wide area network data deduplication unit, a secure remote network connectivity unit, a datacenter inbound network routing unit, a datacenter perimeter security unit, a datacenter LAN segmentation unit, an incoming verification server, and a script processor configured with one or more automated scripts for processing the copies that are received from the CPE servers.

In an embodiment, a data center is configured to receive transmissions of the copies of the servers, applications and data for all the active sites and all the business entities, to store the copies in a demilitarized zone (DMZ) storage tier of the data center with secure segregation of the copies associated with different business entities, to verify the copies in the DMZ storage tier, to store the copies in the online accessible secure storage of the data center with secure segregation of the copies associated with different business entities, and to concurrently move one or more other instances of the copies from the online accessible secure storage to archival storage of the data center with secure segregation of the copies associated with different business entities.

In an embodiment, a data processing method, comprises, at a plurality of customer premises equipment (CPE) servers located at a plurality of different active sites, each of the CPE servers comprising a local storage unit, collecting one or more copies of one or more servers, applications or data of the active site at which that CPE server is located and storing the copies in the local storage unit of that CPE server; at one or more data centers each comprising a data storage and compute unit that is coupled to the CPE servers through a network, receiving transmissions of the copies of the servers, applications and data, to verify the copies, and storing the copies in online accessible secure storage that is segregated by business entity; receiving, a request from a particular active site to restore one or more data elements contained in the secure storage of the data storage and compute unit associated with the particular active site; activating the one or more data elements; and providing the particular active site with online access to the one or more data elements that are inflated.

Other embodiments provide a computer-readable storage medium storing instructions which when executed cause performing the functions described herein.

### BRIEF DESCRIPTION OF THE DRAWINGS

In the drawings:

FIG. 1 illustrates a service provider that provides a disaster recovery system, in relation to an active site and a recovery site.

FIG. 2 illustrates basic functions of the system of FIG. 1.

FIG. 3 illustrates storage elements organized in tiers and in association with operations that interact with specific tiers.

FIG. 4 illustrates an example of an architecture for a data center.

FIG. 5 illustrates an embodiment of the service provider in more detail.

FIG. 6 illustrates flows of data in collection, transmission, verification, and recovery operations.

FIG. 7 illustrates an example general purpose computer system that may be used to implement aspects of an embodiment.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

1.0 Overview

One embodiment provides a global, modular business continuity and disaster recovery system and management platform for delivering highly available disaster recovery managed services. In an embodiment, a scalable system that is adaptable to a wide variety of customer requirements is provided, and the system can be delivered as a managed service.

In an embodiment, a disaster recovery system comprises a plurality of application programs that are responsible for different aspects of collecting, transmitting, validating, storing, archiving, and recovering customer servers, applications and data. The disaster recovery system is configured so that the application programs of the disaster recovery system may be securely shared by different customers, who may be competitors. In an embodiment, a secure sharing policy is defined for each customer, server of that customer, and application of that server of the customer. The policy may be made consistent with the customer's existing security domains or policies. For example, the disaster recovery system can replicate a customer's user role database, and then map the role information in the database to the disaster recovery system's sharing policies. As a result, a customer's existing security policies can also govern user access to the disaster recovery system and its resources.

A plug-in architecture in certain embodiments enables a secure, shared infrastructure to be used by multiple datasets and server replicas of different customers, who may be competitors with one another, and enables the system to benefit from future development. The plug-in architecture also enables handling any number of protected layers of servers or applications at a customer site.

In an embodiment, a database of business continuity-disaster recovery results is created and stored for each customer. The results may be used to generate a rating of disaster preparedness based on particular metrics. The results may be used to report relative customer performance in comparison to peer customers.

In an embodiment, the disaster recovery system comprises a management application that interfaces to a services application programming interface (services API) that implements particular disaster recovery functions. The management application communicates with the services API using a protocol of calls and responses. With this approach, the management application can be modified without affecting underlying services, or the management application can be removed and a different application can be substituted.

In an embodiment, the management application implements a recovery forecasting function in which a customer or an administrator can simulate disaster recovery by temporarily activating a customer's stored applications, servers and data. This approach enables the system to verify the ability to recover applications, servers and data at the time of an actual disaster.

In an embodiment, a managed service is configured to back up and protect computer program servers, applications and data. Existing network connections of customers of the managed service are used to safely move applications, files, and data sets offsite. If a disaster occurs, the service can rapidly inflate the applications, files and data sets for temporary use by the customers until the disaster is mitigated.

In an embodiment, a managed service provides physical-to-virtual conversion, WAN optimization, secure network tunneling across the internet, virtualization, data deduplication, backup/restore, secure LANs and VPNs, multi-tiered storage, data replication, high availability, and many others, and converts them into an abstracted platform capable of hosting multiple customers, across multiple geographies, in a secure multi-tenant configuration. In an embodiment, the managed service enables security and scalability across technologies, and takes into account the future possibility of new technologies which may become included in the platform.

In an embodiment, the disaster recovery system may comprise the following, which are described further herein:
hardware elements such as storage, network infrastructure, servers, datacenters, cables, power, and purpose-built appliances;
software elements such as virtualization, operating systems, virtual networks and virtual storage, security pieces, portal software frameworks;
services such as backup/restore, grid computing, storage service providers, and software-as-a-service;
integrating logic that connects the elements and services with common business continuity, multi-hosting, scalability, and security processes.

In an embodiment, the integrating logic is implemented using scripting, manual operation of certain devices, object-oriented relationships between devices and policies, and interfaces (APIs, SDKs, schemas, and data description formats), databases for capturing and persisting relationships and state, service interfaces for automated integration with offerings from other companies, and programmatic integration with customers.

Thus, a business continuity solutions platform has been described that enables secure, shared access to ever changing combinations of technologies.

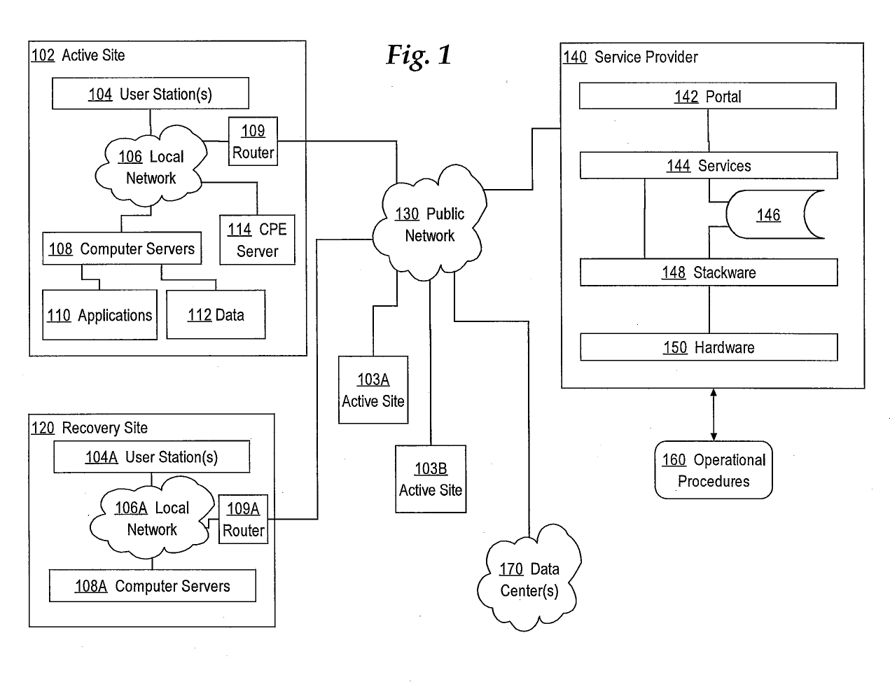

FIG. 1 illustrates a service provider that provides a disaster recovery system, in relation to an active site and a recovery site. An active site 102 is coupled through a public network 130 to a service provider 140. In an embodiment, active site 102 represents a business enterprise, other institution, or other entity that is a customer of the service provider 140 for disaster recovery services. For example, active site 102 is a small business, medium-sized business, or other entity of any size. Active site 102 comprises a plurality of user stations 104 coupled to a local network 106 that has connectivity to public network 130 through router 109. One or more computer servers 108 are coupled to local network 106 and host applications 110 and data 112. User stations 104 may comprise personal computers, workstations, or other computing devices. As an example, one of the user stations 104 comprises a browser that can access HTML documents that the service provider 140 generates; in other embodiments, user stations need not be located at the active site 102 and need not use HTML for communications.

Network 130 may comprise a plurality of public internetworks such as the common Internet. Alternatively, network 130 may represent a private point-to-point connection of the active site 102 to the service provider 140 or data centers 170. For example, the active site 102 could use the Internet to connect to service provider 140 to use portal 142, but have a private point-to-point connection to one of the data centers 170.

Service provider 140 comprises a portal 142, services 144, database 146, stackware 148, and hardware 150, each of which is detailed in other sections below. In general, portal 142 comprises a management application that administrators or other users associated with active site 102 and service provider 140 can use to access and manage disaster recovery services provided by other elements of the system of the service provider. In various embodiments, portal 142 provides a unified dashboard for customer interaction with the system, implements an incident command center, implements business continuity planning functions, and implements chat between customers and personnel of the service provider.

The owner or operator of active site 102 may enter into a service level agreement (SLA) with service provider 140 to define what data collection, verification, storage, archiving, and recovery services are provided. In an embodiment, the SLA states business rules for continuity or disaster recovery expressed in terms of a technical implementation. For example, an SLA could provide that the service provider “shall make available a secure instance of Microsoft Exchange Server for two (2) years.” The SLA may be expressed in a structured language that is optimized with respect to business continuity issues.

The services 144 comprise one or more application programs or other software elements that implement services such as status, reporting, automation of data movement operations, etc., as further described herein. Services 144 may be coupled to portal 142 through an API that enables applications other than the portal to access the services. Database 146 stores administrative information about what servers, applications and data have been backed up for customers, accounting data regarding customer subscriptions, audit trail data, etc.

The stackware 148 provides management functions for the hardware 150 including monitoring, auditing, backup of servers, applications and data, restoration, data movement, virtualization, etc. In an embodiment, stackware 148 comprises an integration layer consisting of container classes that provide interfaces to servers, applications, and hardware elements represented by hardware 150.

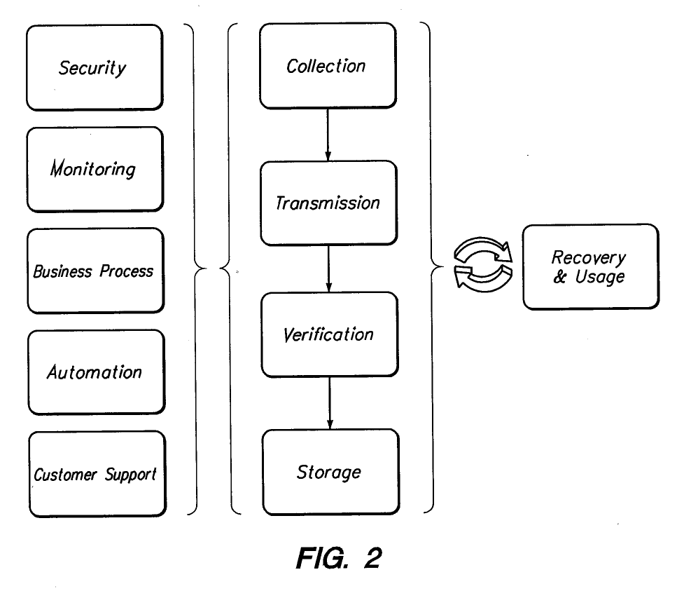

In an embodiment, stackware 148 implements basic functions for disaster recovery and business continuity. FIG. 2 illustrates basic functions of the system of FIG. 1. In general, stackware 148 can perform collection of copies of images of servers, applications and data from a customer location such as active site 102, transmission of the copies of images from the active site to the service provider, verification of the collected and transmitted servers, applications and data, and storage of the servers, applications and data in longer-term storage either at the service provider 140 or in a separate data center. Further, when a customer needs to restore or recover the use of the servers, applications and data, the stackware 148 facilitates recovery and usage. Each basic function is described further herein in sections below. During all such processes, stackware 148 provides security services, monitoring services, logic for ensuring conformance to customer business processes, automation of the collection, transmission, verification, storage, and recovery, and customer support functions.

Hardware 150 represents disk arrays, storage area networks, CPU arrays, and communications hardware such as routers, switches, etc. In an embodiment, hardware 150 may be located at or provisioned by a third party including as a service. For example, computing operations may occur in various embodiments using hardware blades at service provider 150, recovery site 120, unused computing cycles at other customer sites, or through other service providers that offer remote computing services.

Service provider 140 also comprises a plurality of operational procedures 160 that personnel of the service provider use to operate the portal, services, stackware and hardware to deliver a managed service.

One or more data centers 170 are coupled to public network and are accessible to service provider 140 over a wide area network (WAN). Generally, data centers 170 comprise a secure repository for backed up copies of servers, applications or data of the active site 102. Data centers 170 also can host and test applications on behalf of customers of the service provider 140. Data centers 170 may be co-located with service provider 140, or co-located with active site 102. For example, a data center 170 could be located at one active site 102 and provide data storage for that active site and other customers of the service provider 140 that are in locations other than active site 102. Alternatively, data centers 170 may be remote from the service provider 140 and the active site 102.

The stackware 148 and hardware 150, alone or in combination, may be used to implement data storage and compute units to implement the functions described herein, in service provider 140 or in data centers 170.

FIG. 1 also depicts a recovery site 120. In an embodiment, in operation, service provider 140 performs data collection and application collection operations for the computer servers 108, applications 110, and data 112 of active site 102 so that the servers, applications and data are available on hardware 150 whenever a disaster occurs. In that event, optionally the owner or operator of active site 102 may elect to move its operations to recovery site 120. Movement may be physical or may be virtual. For example, in various embodiments, a user may use a personal computer to access virtualized versions of a user station 104. In an embodiment, service provider 140 may or may not offer physical work areas for customers, or the service provider may offer such areas through a partner entity. For example, if active site 102 experiences a fire, flood, earthquake, or other natural disaster it may be necessary to abandon the active site at least temporarily and establish business operations elsewhere. Recovery site 120 represents a temporary operational location and comprises user stations 104A, a local network 106A, network connectivity to public network 130 through router 109A, and computer servers 108A. In this arrangement, user stations 104A may access backed up applications 110 and data 112 on hardware 150 using processes that are described further herein. Alternatively, in a recovery operation, operational copies of the backed up applications 110 and data 112 may be moved to computer servers 108A and used locally.

For purposes of illustrating a clear example, FIG. 1 illustrates a service provider 140 having a customer relationship to active site 102 and in which the functions of portal 142, services 144, stackware 148, etc. are offered as a managed service. However, embodiments are not limited to a managed service offering, and the portal, services, and stackware may be implemented as one or more packaged software products that an entity may install and host without having a separate service provider. In such an embodiment, data centers 170 may comprise a facility that is owned, operated, or otherwise associated with active site 102, or a co-location facility, for example. All data storage units described herein may comprise processors or other computing capability and may comprise the combination of a data storage device with a server or other processor.

2.0 Example Implementation of Disaster Recovery System

2.1 Computer Architecture for Service Provider System

For purposes of illustrating a clear example, this section identifies certain specific software and hardware elements that may be used in an embodiment. However, the specific elements identified herein are provided only as examples, and other specific elements that are functionally similar may be substituted in other embodiments. Further, the designs herein are not specific to a particular type of hardware or software, and are not specific to a particular manufacturer of hardware or software. As an example, the disclosure herein specifies a certain network security layer as comprising a firewall, but in alternative embodiments the security layer may be implemented using a cryptology module implemented in software, or a reuse of a customer's existing firewall with a security partition that describes elements of the system herein, a third-party hardware appliance other than a firewall that includes a cryptographic subsystem, or other elements.

In an embodiment, service provider 140 is configured for collecting data from a connection between customer servers 108 and a CPE Server 114 that is owned by the service provider but installed on the customer premises at active site 102. In this context, collecting data refers to creating and storing copies of images of servers, data, and applications, including one or all servers, applications and data present on a particular computer. Collected data may comprise server images, file images, application images, etc. Alternatively, collecting may refer to copying configuration settings only and not actual servers, applications or data. For example, service provider 140 may elect to host its own instances of commonly used business applications such as Microsoft Active Directory, Exchange Server, Sharepoint, Dynamics, SQL Server, etc., and collect only customer-specific configuration data for these applications. This approach reduces the volume of data that is collected.

Additionally or alternatively, service provider 140 may perform collecting data using one or more manual steps. For example, collection may comprise receiving recorded data media, such as tapes, disk media, or other data storage media by postal mail, courier, or hand delivery, and manually loading data from such media.

Other embodiments may omit CPE server 114, or may use a virtual device to perform data collection.

In an embodiment, CPE server 114 comprises a server-class computer such as the Dell PowerEdge 1950 and hosts Virtual Image Capture Software, such as VMWare Converter, and an Operating System, such as Microsoft Windows. The size of the CPE Server 114 in terms of CPU speed, amount of RAM, and amount of disk storage may vary depending on the number of servers, applications and data at a particular active site 102. Depending on the location of the CPE Server or customer requirements for security or confidentiality or regulatory requirements, CPE Server 114 may use encrypted storage drives for enhanced security, Microsoft EFS, other secure file systems, encryption performed in a desktop application such as PGP, or other security measures.

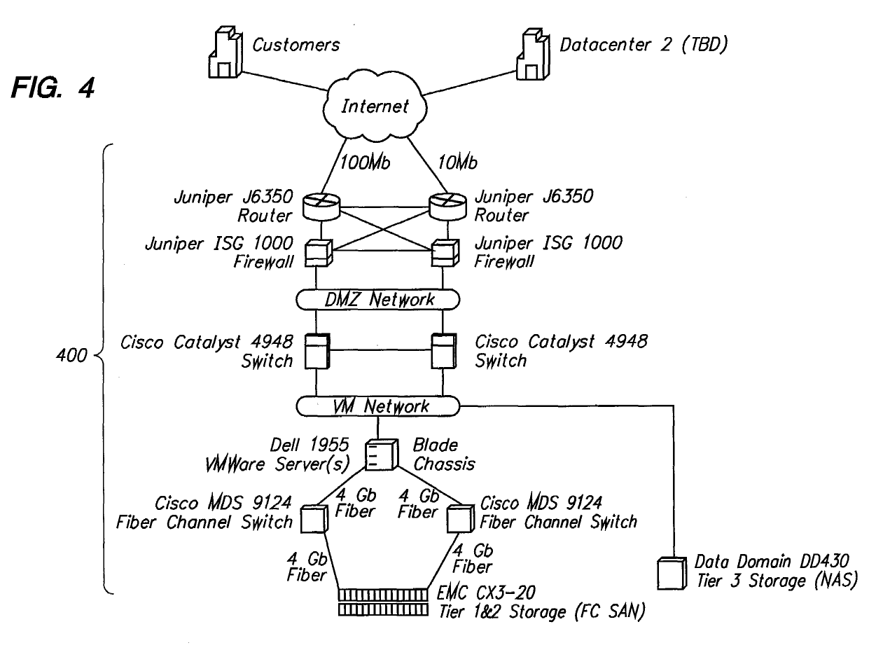

Virtualization software other than VMWare may be used. Virtualization on CPE Server 114 in cooperation with the VM network of a data center (FIG. 4, described further herein) implements an abstraction layer that decouples the physical hardware from the operating system of the CPE Server to provide greater resource utilization and flexibility. For example, multiple physical servers of customers can be converted to virtual machines and run on one blade server in a data center. If a 6-blade server is used in the data center, then about 72 virtual machines can run simultaneously.

The Virtual Image Capture Software serves as an agent on CPE Server 114 to convert physical servers 108 to virtual servers and images. Thus, the agent enables the CPE server 114 to obtain operational information about the servers necessary for proper re-activation of the servers when a recovery and usage event occurs.

In an alternative embodiment, collection is facilitated by installing a backup agent on servers 108. An example backup agent is CommVault. The backup agent transparently periodically provides backup image copies of servers 108 to the CPE server 114 in response to requests from the CPE server or on a scheduled basis.

The virtual image capture software may be configured to perform a security analysis of the customer environment. For example, while collected data is stored on the CPE Server 114, logic on the CPE server can scan the collected images and determine whether certain security elements are present or missing, such as a particular release of anti-virus software. If the security elements are missing, then the logic of the CPE Server can automatically install the security elements, inflate them, and inform the active site 102. Local operations such as security installation may be performed as an extra-cost or value-added operation of the service provider 140. Network vulnerability assessments, SAS IT audits or compliance reviews, security audits, and other processes can be performed in the CPE Server 114 based on collected data images, and the results can be reported to the active site 102. However, the use of network vulnerability or security assessments, reviews and audits are not essential to embodiments, and may be omitted.

Software on the CPE server 114 may be configured to perform compression and encryption to reduce transmission time to service provider 140 and to provide encrypted packet payloads for additional security.

In an alternative embodiment, CPE server 114 is not used. Instead, active site 102 is provided with a network pointer with security algorithms applied to a secure data collection element or “lock-box” that service provider 140 maintains in hardware 150 or in data centers 170 on behalf of the active site. In this alternative, the active site 102 would install a software element, execute the element, use the element to select a target location affiliated with the service provider 140, e.g., based on the geographical location of the active site, and the element would automatically transfer data to the secure data collection element.

In an embodiment, service provider 140 is configured for transmitting data collected from the active site 102 on the CPE Server 114 to data center 170. Certain embodiments herein are optimized for transmission of relatively large datasets, such as images of entire servers, with acceptable speed over a connection of the active site to network 130 that is shared with other customer activities; however, in environments in which datasets are small, other arrangements of hardware and software may be used to yield acceptable time results with such shared connections. Further, because embodiments involve transmitting confidential or sensitive data from active site over a public network 130, certain embodiments comprise technical elements to ensure secure transmission.

In an embodiment, service provider 140 owns, operates or is associated with one or more data centers 170, which may be geographically located anywhere having connectivity to the common Internet and need not be located at the service provider's location. In an embodiment, hardware 150 comprises a Remote Wide Area Network (WAN) data optimization element, such as a Silver Peak NX-2500, Riverbed Steelhead 200, etc. Use of a hardware data optimization element improves transmission efficiency by rapidly inspecting large datasets, encoding the data (e.g., as hash values), identifying variances among successive encoded data segments, and transferring only the variant data rather than transmitting all the data. While this approach is effective, other data compression or efficiency approaches may be used.

In an embodiment, to support IPSec for multiple connections without having a separate hardware element to terminate each IPSec tunnel, a Secure Remote Internet Connectivity element is used, such as a Juniper SSG-5 Firewall, which can terminate multiple IPSec tunnels for receiving encrypted transmissions of data from many different customers even when several customers use the same internal IP subnet scheme.

In an embodiment, each of the data centers 170 has a network architecture 400 as seen in FIG. 4 and comprises a Datacenter Inbound Internet Routing element, such as Juniper J6350 routers, a Datacenter WAN optimization element, such as a Riverbed 200 in the DMZ network, a Datacenter Perimeter Security element, such as one or more Juniper ISG1000 firewall devices, and Datacenter LAN segmentation elements, such as Cisco Catalyst 4948 Gigabit Ethernet switches or other Layer 2 switches. This arrangement enables a data center 170 to accept a large number of inbound connections and to separate and prioritize the incoming traffic. Prioritization may be appropriate for a variety of reasons; for example, a particular priority may be an extra-cost item, or a customer SLA may specify a particular time window for performing transmission, backup, or restoration, or different customers may have different rules about what data is allowed to be transmitted or restored. BGP route preference may be used to achieve aspects of prioritization.

In an embodiment, the Datacenter Perimeter Security element provides multiple security layers including IPSec VPN capability, active intrusion detection, and active security monitoring. For example, in each of the data centers 170 two firewall devices may be used in an active-passive cluster to provide failover capability. Operationally, the firewall devices are configured to aggregate a large number of IPSec tunnels, identify tunneled traffic, and map data payloads carried in the tunnels to VLANs. The firewalls also may perform logging, monitoring, or manipulation of the data elements to secure the data including intrusion detection, anti-virus service on inbound payloads, etc. Consequently, for the data centers 170, the service provider 140 can identify existing and potential threats, perform a functional risk assessment for all network elements, implement a risk abatement model, and implement countermeasures and changes as threats are identified, within a security sub-layer implemented at the perimeter of the data centers.

In an embodiment, the Datacenter LAN segmentation elements specify the division of VLANs to provide Layer 2 data segregation. In an embodiment, VLAN segmentation is provided per customer, and within each customer, IP subnets may be divided by service of that customer. For example, transmission, verification, and storage traffic for a customer may be associated with different IP subnets of a VLAN for that customer. This approach provides a modular design that allows the service provider 140 to change its design of the services easily.

Using these elements, service provider 140 may establish multiple virtual local area networks (VLANs) in data centers 170 and may use policy-based BGP routing for the purpose of separating or segmenting traffic associated with different customers and establishing scalable IP subnets that are divided by service type (e.g., voice, data). In this approach, inbound BGP routes are mapped using policies to different VLANs on a per-customer basis, and customers are associated with ingress points rather than subnet addresses, because subnet addresses of different customers may overlap.

Further, the use of VLANs, several thousand of which can co-exist on a single physical switch, allows prioritization based on QoS for a particular service type or customer, and ensure that the data of one customer is inaccessible to other customers. For example, the association of a particular customer to a particular VLAN enables the system to distinguish among inbound traffic from two servers of two different customers that have been assigned the same private network address within the LAN of the customers.

In an embodiment, network architecture 400 further comprises a virtual machine (VM) network or “grid” behind the switches and comprising one or more virtual machine servers (e.g., VMWare servers), which may be configured using blade chassis server units or a third-party computing grid or grid elements. The VM network further comprises one or more fiber channel switches and SAN array storage units forming a storage area network (SAN) that implements storage tier 1 and storage tier 2 of a tiered storage model that is further described herein. In this arrangement, four (4) paths exist from every server to the data on the SAN. The storage tier 3 may be implemented using network attached storage that is coupled to the VM network.

Service provider 140 may be connected to data centers 170 using any form of data connection. In various embodiments, microwave, optical, or other high-speed connections are used. In an embodiment, service provider 140 and CPE Server 114 have wide area network (WAN) connections to data centers 170 structured to be reliable, scalable, capable of handling multiple customers, and capable of secure transmission and receipt of data. WAN connectivity from CPE Server 114 to data centers 170 for performing periodic collection operations may be achieved using an existing Internet connection of active site 102 to network 130 by time sharing the connection, prioritizing network usage with appropriate quality of service (QoS) settings, and employing WAN hardware acceleration devices, such as the Riverbed units identified herein. Security on the WAN connection may be achieved using hardware-based IPSec.

The Datacenter WAN optimization element is conceptually configured to receive a series of small data elements, compare them to the last known large data element, and replace the small data elements to yield a favorable new large image. The optimization element can be implemented in hardware or software in various embodiments. For example, a software data optimization engine may be used. Complimentary data optimization engines are deployed at the customer premises, such as active site 102 in association with CPE Server 114, and in the data centers 170.

In an embodiment, service provider 140 is configured for verifying the data transmitted to the datacenter by validating the virtual images that are captured, and recording metadata. Verification also may be performed when images are moved into storage, from storage to the active site 102 as part of a recovery operation, or at any other time when images are moved or manipulated. Verification comprises determining that transmitted data is in the form that is expected (for example, based on a customer SLA), is complete and accurate, belongs to a particular customer and is usable (that is, not corrupted). In such an embodiment, data centers 170, hardware 150 and/or stackware 148 may comprise an Incoming Verification Server, such as a VMWare ESX Server, and programmatic means for Processing Images, such as VMWare VIX scripting.

In an embodiment, service provider 140 is configured for storing the data for near line usage as needed and as described in a contract and SLA with the customer. In an embodiment, hardware 150 and/or stackware 148 may comprise Data Storage elements, such as an EMC Fiber Channel SAN, Storage and Image Server Processing elements, such as Dell PowerEdge 1955 Servers, and a Data Storage Network comprising Cisco MDS9124 Fiber Switches.

In an embodiment, service provider 140 is configured for archiving data, such as performing archiving after verification events if an SLA defines long term data retention plans. A comparison of storing and archiving is provided in other sections herein. In general, archiving provides remote storage of data and thereby improves survivability of data when a configuration of data centers 170 changes. In an embodiment, a subset of customer data may be retained at the CPE Server 114 for rapid recovery if necessary. In an embodiment, archiving is facilitated by Archival Storage elements, such as Data Domain DD430 storage, which can perform hardware data de-duplication. Archival storage elements also may implement data storage compression to reduce the amount of disk space occupied by data that is in long-term storage. Archival storage elements may implement archival lookup engines, data classification engines, and regulatory compliance modules configured to review data in archival storage for compliance with various regulations. Decompression is performed as part of recovery of images that are placed in archival storage.

2.2 Collection, Transmission, Verification, Storage, Archiving, and Recovery/Usage Functions

In an embodiment, stackware 148 comprises program code and data elements that implement Collection, Transmission, Verification, Storage, Archiving, and Recovery/Usage functions, each of which is now described.

Collection generally refers to copying servers, applications and data from servers 108, applications 110, and data 112 to CPE Server 114. However, storage of collected data at the active site 102 is not required, and other embodiments may collect data from an active site directly to storage associated with the service provider 140 without persisting the data at the active site in the CPE Server 114 or in other local storage. In an embodiment, collection is implemented in stackware 148 using code to define collection modalities, meaning what data to collect and when to collect it. Collection modalities may be defined, in an embodiment, in a business process language or other symbolic representation in an SLA. An example SLA term might be “Collect Microsoft Exchange Server once per day at 02:00 and store for 30 days in archival storage.” Code to define modalities may comprise logic configured to transform the symbolic representation into technical terms that are stored in database 146, and code for querying the database 146 to retrieve for a particular customer technical parameters that specify what data to collect, when, and from where.

Collection in stackware 148 further comprises code to map the modalities to business processes or SLA requirements, code to execute collection routine(s), code to report on execution, and code to schedule or automate the timing of collection. Tables, relationships, or procedures in database 146 may serve to map SLA terms or business process terms for modalities into technical parameters or attributes for data collection operations, such as server addresses, network segments, software installation identifiers or license keys, file system folder locations, expected size of the data, commands used to collect the data, time intervals, absolute or relative collection time values at which time intervals begin or end, rules for implementing collection such as waiting for a data element to become idle, rules for performing storage, etc.

The code also may comprise functions in portal 142 to facilitate looking up collection modalities for a particular customer, and/or display the modalities including SLA terms and corresponding technical parameters.

The code to execute collection routine(s) may integrate with database 146. For example, database information may specify that a particular script should be performed a particular number of times on particular servers to accomplish collection. Database information may reference other executable elements relating to collection, such as pointers to wrapper code that can activate scripts for performing collection operations or to an inbound parser that can read collected data, generate metadata in XML, and store the metadata in the database. For a different customer, the database may reference other executable elements that are different in programming language format and substantive functions.

The code to report on execution may indicate, for example, that a particular collection operation completed, what was collected, a timestamp, source and target addresses for collection, server markings or names of the collected data, SLA terms authorizing the collection, or other metadata relating to a collection operation. Reported information may be stored in database 146 and available for display in text form for human review or automated correlation to SLAs.

The code to schedule or automate the timing of collection is implemented in stackware 148; thus, collection is performed in a push capacity in which the stackware instructs the CPE Server 114 to perform collection according to SLA terms or database parameters. Because the code to schedule such collection is separate from the CPE Server 114, the stackware 148 can continue to operate when the CPE Server is unavailable. Execution of timers and performing actual collection operations may be coordinated using one or more central command/control servers at service provider 140 forming part of stackware 148.

In an embodiment, CPE Server 114 is configured to inform an administrator of active site 102 about an upcoming scheduled collection operation and to allow the administrator to override the operation. Further, stackware 148 may comprise monitoring logic that detects when successive or repeated override requests have caused collection operations to diverge from SLA requirements, and report non-conformance to an administrator of service provider 140 and/or active site 102.

However, the impact of non-conformance to SLAs for collection is mitigated by the ability to store in storage tier 4 a most recently collected set of data for some or all of the customer servers, applications and data that the customer wants to back up. Thus, if transmission to a data center 170 becomes impossible due to a failed link, a time delay resulting from rerouting of customer traffic from a failed link over a new link to a different data center 170, or repeated overrides by an administrator, and the customer experiences a failure, the CPE Server 114 has remote survivability because the CPE Server can continue to collect data backups locally, perform verification locally, and can be used as the basis for a recovery operation for at least some data, for example, in a micro-failure scenario. Still further, because CPE Server 114 typically has an independent link to service provider 140 separate from links to data centers 170, the service provider can continue to monitor the CPE server.

Collection may be initiated by stackware 148 securely sending a collection request to the CPE server 114. In response, the Virtual Image Capture Software starts a physical-to-virtual conversion operation on each of servers 108. Alternatively, CPE Server 114 initiates a backup job (for example, a CommVault backup job) using internal drives of the CPE Server as the destination drive for backup. In either alternative, virtual images and backup files are stored on CPE internal storage. When the jobs are complete, the CPE Server 114 sends a status message to the stackware 148. As a result of collection, images of servers 108 or backup files are stored on local disk drives of CPE Server 114. Checksum and logging routines may be performed on each image or backup file that is collected, to perform an initial basic verification.

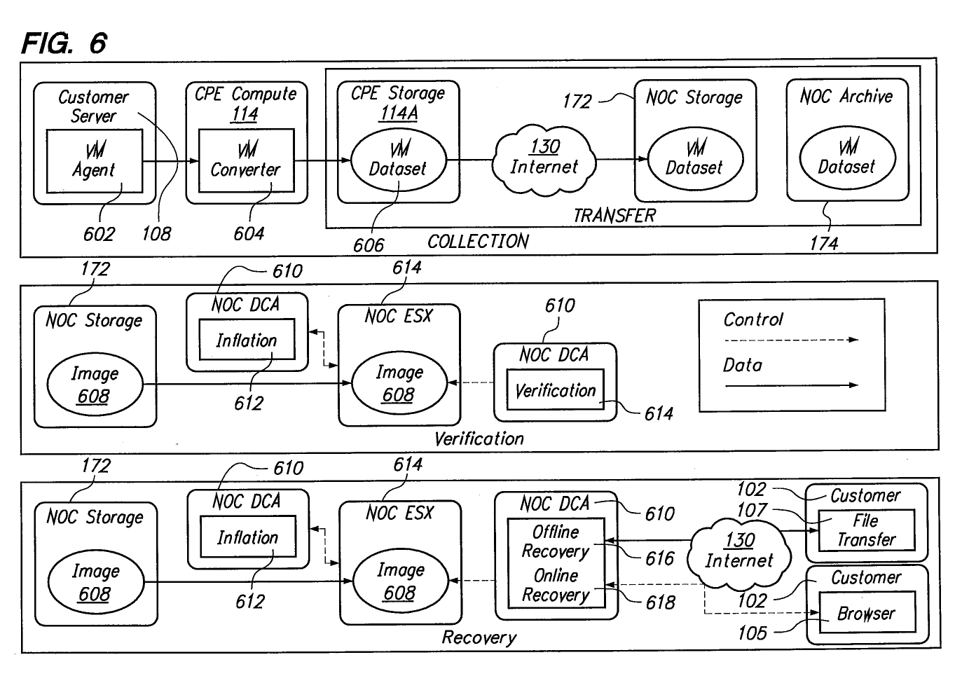

FIG. 6 illustrates flows of data in collection, transmission, verification, and recovery operations. In collection, a virtual machine agent 602 hosted on one of the customer servers 108 communicates with virtual machine converter 604 on CPE Server 114 to accomplish conversion of the customer server 108 to a virtual machine dataset 606, which is temporarily stored on CPE storage 114 in the CPE Server.

Transmission generally refers to moving, from CPE Server 114 to data centers 170, data that has been collected from the active site onto the CPE Server. Transmission is decoupled from collection to allow for transmission and collection to be scheduled at different times. In an embodiment, a user of the active site 102 or the service provider 140 can interact with a transmission option of the portal 142 to select one or more images, or all images, for transmission from the CPE Server 114 to data centers 170; alternatively, selection of which data to transmit may be performed automatically. In an embodiment that uses a secure online “lock box” and does not use CPE Server 114, transmission may not be required.

In an embodiment, transmission is implemented in stackware 148 using code to initiate a one-way or two-way transmission of customer data from the CPE Server 114 to one or more of the data centers 170. In an embodiment, transmission occurs in response to a collection result event indicating successful collection. Alternatively, transmission can be scheduled at any suitable time. In an embodiment, transmission is implemented in stackware 148 using code to report on execution of transmission operations and code to receive, log, categorize, and “label” new data in the datacenters 170. For example, metadata to indicate what was captured from the CPE Server 114 may be created and stored in database 146. In an embodiment, transmission is implemented in stackware 148 using code to schedule and automate the timing of transmission, which may be coordinated using one or more central command/control servers at service provider 140.

In an embodiment, when collection is complete, stackware 148 securely sends one or more FTP copy requests to the CPE Server 114. In response, the CPE Server 114 initiates an FTP send operation for all collected images or backup files to an inbound storage demilitarized zone (DMZ), described further below, which serves as a temporary secure storage location, segregated by customer, for data at service provider 140. The storage DMZ may be implemented using hardware 150 or at data centers 170, which are provided with a hardened FTP daemon on a blade server. Each blade server may be configured with access to tier 1 storage as defined herein, the DMZ network, VMWare executables, and backup server software such as CommVault using a virtual machine guest image. The FTP operation may be optimized using a Remote WAN optimization element at the active site 102. As a result, a copy of customer images or backup files arrive at the service provider 140, or data centers 170, and the images and files then await verification.

Referring again to FIG. 6, in transmission (or transfer), the virtual machine dataset 606 moves across network 130 to network operation center (NOC) storage 172, which is in one of the data centers 170. Additionally, the dataset 606 may be moved to NOC archive storage 174 for longer-term storage, as further described herein.

Verification generally refers to determining that transmitted data has been accurately captured and received. In an embodiment, verification is implemented in stackware 148 using code to identify data images as they relate to the SLA; for example, a comparison between data stored in archive storage and recently captured data may be performed to determine that the correct data was collected and transmitted in conformance with the SLA. Metadata may be created and stored to reflect conformance or variance.

Further, verification code may be configured to individually identify files that are within received images of archives (e.g., ZIP files) so that the database 146 reflects names of individual files rather than opaque archives. This approach enables a subsequent restoration operation to target an individual file rather than the entire archive. In other embodiments, verification code may be configured to individually identify individual database table spaces of a customer, rows and columns of databases, messages within message archives, calendars or other sub-applications within a unified information application, or other units of information. Further, database 146 may serve as a meta-catalog that references other data catalogs represented in storage units of the system, such as a directory maintained in the CommVault system.

Verification also may comprise performing, at CPE Server 114, a check of file name values, date values, checksum values, and other data indicating whether customer servers, applications and data have been collected properly. Such verification may include packet-level verification. Verification also may comprise determining whether collected and transmitted data is capable of installation and operation on another computer system. For example, verification may comprise temporarily activating copies of customer servers or applications using automated scripts to test whether the servers or applications operate properly.

In an embodiment, verification comprises the combination of the following, for each image that is received:
Computing a new checksum on the received image;
Comparing a checksum previously received from the CPE Server 114 before the transmission phase and associated with the same image;
Running, on the blade server that hosts the FTP server, a VIX-based verification script against each image, for purposes of validating logical correctness of the images, rather than physical correctness;
Providing results to a command/control server.

In an embodiment, verification is implemented using code in stackware 148 to segment the images into secure area(s) in data centers 170, which may include moving data among different storage tiers that are established in the data centers. In an embodiment, verification is implemented in stackware 148 using code to report on security and user level details, which is configured to identify when a user is attempting to perform or schedule a backup operation for a server, application or data that the user would not have access to use, and to configure the automation services of stackware 148 to implement the same privilege restrictions. Such code may be responsive to business rules stored in database 146 that define user privileges, or stackware 148 may be configured to use or access a user profile database at active site 102. In an embodiment, verification is implemented in stackware 148 using code to run test routine(s) on data elements, and code to schedule or automate the timing of verification.

In an embodiment, verification is performed at two levels and a third level may be offered as an extra-cost option. The first level comprises performing a cursory check of data integrity at the data collection point, CPE Server 114. For example, when a collection operation is a data backup operation, the check may comprise comparing file size of the original file and the backup copy at the CPE Server 114. Alternatively, the cursory check may comprise computing a checksum as stated above, or for an application, invoking an instance of the application and pinging a TCP port that the application uses to verify that the application is active.

In an embodiment, the second level comprises finer-grain checks in transmission such as verification at the packet level. Other second-level verification may comprise examining router syslog data to determine whether transmission was successful. Second-level verification may comprise inflating a backup copy of a data element, making the data element usable by installing it as a server or application, activating the data element, and running a series of scripted tests such as pinging an open TCP port, logging in with an administrative userid, etc. When a virtual image has been created, second-level verification may comprise using an automated script for starting the virtual machine, taking a snapshot of the image to enable rollback in the event of a problem, changing the IP address of the VM to fit a common IP scheme, pinging the new IP of the VM to ensure that a correct response is received, telneting to the application port(s), and shutting down the VM to prepare to move the image into a storage array.

Third-level verification may comprise starting an application image and performing operations that users would actually perform to definitively confirm that the application operates properly. Third level-verification could be performed by personnel of the service provider 140 or the active site 102; that is, customer personnel could be permitted to access application instances at data centers 170 for the purpose of verifying that a backed up, re-inflated application image or server image is operational. In an embodiment, a SLA for a customer can define different levels of verification to be performed for different servers, applications or data of the customer. Second-level verification and third-level verification may be performed when images of applications, servers or data are in the storage DMZ, described further herein, or in general image storage locations or archive storage.

In an embodiment, verification may be performed in response to a customer request, or in response to an operator command using portal 142. Thus, in an embodiment a customer can access and test stored image by accessing portal 142 and submitting a verification request for specified images. In an embodiment, enhanced or additional verification steps may be specified and performed for one or more selected images among all a customer's images. For example, basic verification may be performed on every virtual machine image after the image is received in a data center, and additional verification may be offered to customers as an extra-cost item. Examples of enhanced verification steps include backup software testing by performing a restoration of all files that were collected, automatically or using tape backups; live receiver operation by hosting a virtual machine target as the receiver of the backup files, incorporating inbound backup delta data, and testing an application live; providing basic log and audit data including examining information provided in logs and backup database repositories, parsing for anomalies, or building automated test scenarios to investigate anomalies.

In one embodiment, Incoming Verification Server 614 is configured for test operation by testing an application live. Using this approach, the service provider 140 or a user associated with the active site 102 can test the capability of the service provider to successfully implement a disaster recovery or business continuity operation, without performing a disaster recovery, without actually moving data or applications to the recovery site 120 or without actually hosting applications or data at the service provider or recovery site for a long time period.

For example, referring again to FIG. 6, in response to a request from an administrative console or user of active site 102, Incoming Verification Server 614 or associated verification logic causes instantiating or activating a virtual machine. In an embodiment, service provider 140 hosts one or more virtual machine servers, such as ESX server 615, and for test operation the service provider instantiates or activates one or more virtual machines on the ESX server. The ESX server is configured to host a virtual machine operating system that can operate multiple virtual machines, such as ESX from VMWare, but other operating systems or virtual machine environments may be used in other embodiments. The virtual machine servers may be hosted in data centers 170. Under manual control, script control, or other automatic program control, a stored server image or application image 608 is moved from NOC storage 172 to Incoming Verification Server 614. Inflation logic 612 hosted in a server 610 of the NOC instructs the Incoming Verification Server 614 to inflate the image. Inflation comprises decompression and installation. Any stored difference information or “backup delta” information is applied to the image 608. The image 608 is activated or launched on the virtual machine. Thereafter, personnel associated with the active site 102 or the service provider 140 may test one or more applications or functions live by interacting with the inflated application images. In such testing, the service provider 140 may perform the preceding functions and steps, and then a user associated with active site 102 can connect to the application on the virtual machine and perform desired testing.

In an embodiment, live testing is performed without connecting the virtual machine to a public network such as the Internet, to prevent introduction of unwanted data or unwanted interactions with the customer servers, data or applications, and users connect to the inflated servers, applications or data using computers in the data centers or in a private network or virtual private network provided by the service provider.

In an alternative embodiment, live testing may be performed by moving a copy of customer servers, data or applications to one or more real or physical test computers, arranged as a single test computer, a cluster, a scalable grid of test computers, or other test computing fabric or arrangement, rather than virtual machines. rather than virtual machines. In still another alternative, data centers 170 may host one or more pre-configured application servers for various applications, and testing may comprise moving a copy of customer-specific data to such servers to result in customizing or applying a customer-specific personality for the application to the servers. For example, data center 170 may host a computer that is pre-configured with Microsoft Exchange Server, and live testing may consist of moving the Exchange Server data for a particular customer from archive storage to the pre-configured server, rebooting the server with the customer data, and allowing the customer to test the server to verify that the customer's data has been successfully introduced and is operational.

Through this approach, any changes to application data that occur as a result of application operation or user interaction occur only in a copy of data held in the test machine (whether a virtual machine or a physical machine) and do not affect stored or archived data. If testing reveals problems, then collection, verification, or archive storage operations may be repeated as needed. After testing is complete, under manual control, script control, or other programmatic control, the application and virtual machine may be shut down. Copies of servers, applications or data are retained in archive storage for potential use in future disaster recovery or business continuity operations and are unaffected by the verification operations described herein.

In various embodiments, live receiver test or verification as described herein may be performed when servers, applications or data arrive at tier 1 storage, or long after servers, applications or data are placed in archival storage. In an embodiment, performing live receiver testing as seen in FIG. 6 may comprise moving servers, applications or data from archival storage at tier 3 to inbound verification storage at tier 1 before performing live receiver testing.

In one approach for recovery, a file transfer process 107 at the active site 102 or a recovery site 120 communicates through network 130 to an offline recovery process 616 hosted in the NOC server 610 and obtains a copy of the inflated image to run at the customer site. Alternatively, a browser 105 at the active site 102 or recovery site 120 is used to initiate and control an online recovery process 618, which results in inflating a server or application in the data center 170 for remote access by customer users.

Storage generally refers to managing the storage of collected, transmitted and verified data in secure storage locations. In an embodiment, storage is implemented in stackware 148 and data centers 170 using code to tag data for storage according to the SLA. Tagging may comprise cataloging data and generating metadata for database 146 that describes the stored data. In an embodiment, storage is implemented in stackware 148 and data centers 170 using code to move data elements securely from one data structure to another. Data movement may comprise any of FTP transfers, SFTP, HTTP over SSL, IPSec tunnel transmission, SIFS copy operations, NFS mount operations, SAN-to-SAN transfers, etc. Accordingly, the code to move data elements securely may comprise a library that calls the appropriate storage data element and performs a secure transfer using a specified mechanism based on SLA terms and customer identification. In an embodiment, storage is implemented in stackware 148 using code to run test routine(s) and checksums on data models and code to schedule and automate the timing of storage.

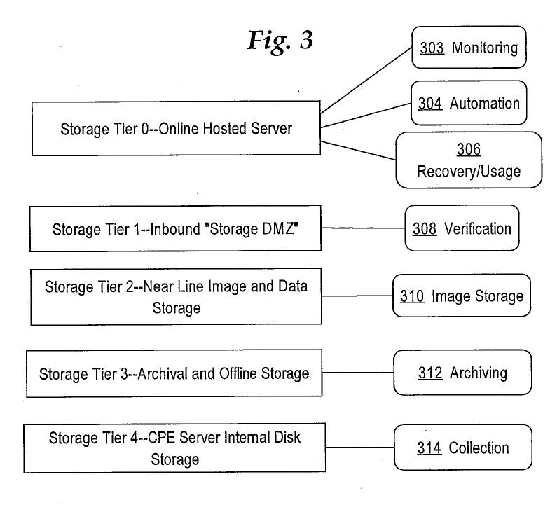

In an embodiment, stackware 148 and data centers 170 implement storage using a tiered storage model for data elements. FIG. 3 illustrates storage elements organized in tiers and in association with operations that interact with specific tiers. Each tier comprises a logical storage construct and is not confined to a particular kind of storage element in hardware or software (e.g., SAN storage, NAS storage). Further, the use of tiers as described herein may vary for each customer, and different customers may use different physical elements or software elements to implement the same tier.

In an embodiment, all storage elements of FIG. 3 may be viewed as arranged in five tiers. Storage tier 0 represents online hosted server storage, the contents of which are immediately accessible and highly available using network communications over network 130. Storage tier 0 is typically used for storing images during a recovery phase when a customer needs immediate online access to stored copies of applications, servers or data. Storage tier 0 may be used for data monitoring 302, automation 304 of transmission and storage of collected data, and recovery and usage 306 of stored data when a disaster occurs or when a customer otherwise needs data. In an embodiment, data monitoring 302 may comprise using a network monitoring system, such as OpManager, to determine whether faults are occurring in any of the data centers 170 and report fault information to stackware 148 for management using portal 142.

Storage tier 1 comprises inline, inbound storage demilitarized zone (DMZ) or protected storage zone that is used to temporarily hold data that has been collected at active site 102 and transmitted to service provider 140 while the data is subjected to verification 308. After verification, data is typically removed from storage tier 1 and stored in storage tier 2.

Storage tier 2 represents near-line rate image and data storage and may be used for general image storage 310. Storage tier 2 is the general repository for customer data that has been collected, transmitted, and verified, when the customer is not paying for or does not need archival storage. Alternatively, a customer SLA can provide that data is always moved to storage tier 3 and not held in storage tier 2. Normally storage tier 2 may store one instance of each customer server, application and data. For example, tier 2 may store instances of customer servers, applications and/or data that require fast processing time, such as applications with rapid requirements expressed in an SLA.

Storage tier 3 represents offline archival storage at data centers 170 or other locations for long-term storage when immediate access is not important. Storage services for tier 3 may be provided by third parties and need not be located in data centers 170. Storage tier 3 is used in archiving 312. Storage tier 3 may store more than one iteration or instance of each customer server, application and data, each instance having a different archive date/time. Different instances of customer servers may be stored in different media, such as tape, inexpensive disk, etc., e.g., depending on the age and/or importance of the instances.

Storage tier 4 represents on site storage, such as internal disk storage of CPE Server 114, and is typically used only for collection 314, but may also serve as a repository for a portion of customer data that might be needed relatively immediately at some point in the future. If a software system is used for collection directly to the service provider 140 or data center 170 then storage tier 4 may not be needed. Storage tier 4 may be implemented as a storage unit that is owned or operated by active site 102 or an agent installed on a storage unit of the active site 102.

In an embodiment, not every customer uses every storage tier. For example, certain customers may elect not to use archival or offline storage at tier 3 but to maintain all servers, applications and data in tier 2 for rapid short-term recovery.

In an embodiment, after customer applications, servers and data are collected, transmitted and verified, storage operations move the customer applications, servers and data from storage tier 1 to storage tier 2. At this time, metadata is created and event information is logged. The original copy of the images in storage tier 1 is then securely deleted.

Archiving generally refers to moving customer data from general data storage to long-term, archival and offline storage. In an embodiment, archiving is implemented in stackware 148 using code to tag data for archiving in accordance with an SLA; for example, data lifecycles may be described in data that is stored in database 146. In an embodiment, archiving is implemented in stackware 148 using code to move data elements securely from one data structure to another, the tiered storage models for data elements shown in FIG. 2, using code to run test routine(s) and checksums on data models, and code to schedule or automate timing of archival. Generally, these code elements operate in the same manner as described above for storage operations.

For example, in an embodiment, each additional collection of the same customer server that is transmitted to the service provider 140 is cascaded from storage tier 1 to storage tier 3 and retained as specified in the SLA with that customer. In this context, cascading means that a previously received copy of a server is moved from storage tier 2 to storage tier 3, and a newly received copy of the same server is moved from storage tier 1 to storage tier 2. As a result, storage tier 2 always stores the most recently collected, transmitted and verified copy of a server image, and storage tier 3 maintains one or more less recent image copies of the same server.

Recovery and Usage generally refers to facilitating recovery of customer servers, applications or data in response to a disaster or customer need. In an embodiment, stackware 148 implements recovery and usage using code to receive customer request(s) for usage of data, which requests may be presented using portal 142, and code to lookup customer information and relate it to archive or stored data elements. Thus, the portal 142 provides a management interface for the customer as well as for administrators of service provider 140, who can access information about all customers or departments of customers. The portal 142 may also comprise user interface elements for requesting data restoration in any of the failure scenarios described herein. The portal 142 also may be configured to receive customer login information or identification information and determine which data elements are stored in each of the storage tiers for that customer, and to generate a display or summary of stored data elements only for that customer, providing a lookup capability for customer representatives.

In an embodiment, stackware 148 implements recovery and usage using code to lookup pre-recovery conditions as captured from the customer. For example, a pre-recovery condition may comprise determining that no change in the customer computing environment at active site 102 has occurred since the customer servers, applications and data were collected and stored. Determining such conditions may be facilitated by obtaining, at the time that a customer becomes a customer, a description of the then-current customer environment for use in comparisons.

In an embodiment, stackware 148 implements recovery and usage using code to move data elements securely from one data structure to another, as previously described for storage operations, and code to manipulate data elements to match recovery needs, patterns of use of the data elements, and pre-recovery configurations. For example, stackware 148 is configured to determine what service level to provide to a customer in the event of a disaster followed by recovery, for example, through a lookup operation with database 146.

In an embodiment, stackware 148 implements recovery and usage using code to modify incoming security blocks to accommodate customer access to data elements. For example, stackware 148 is configured to retrieve data blocks representing stored customer servers, applications and data from archival storage or storage tier 2, and to reassemble retrieved data blocks into servers, applications or data. Such code is useful, for example, when active site 102 and service provider 140 implement a peer-to-peer data transfer model. This approach enables the stackware 148 to partition data transfers that are received in peer-to-peer mode and store portions of data elements separately for reassembly later. Further, this approach enhances security by increasing the difficulty of one customer obtaining complete data elements of another customer.

In an embodiment, stackware 148 implements recovery and usage using code to log, generate alerts, and otherwise monitor use patterns and data element manipulation. In an embodiment, stackware 148 implements recovery and usage using code to automate the timing of recovery or usage, and restoration of data to the verification state. In an embodiment, Perl scripts may be used in conjunction with VMWare to perform recovery or “inflation” of customer servers, applications and data.

In an embodiment, when a customer declares a disaster and invokes service provider 140 for recovery purposes, the following process is performed. One or more scripts retrieve data describing details of the last collection that was performed. Images in storage tier 2 are copied to storage tier 0, and one or more virtual machines are activated. The system activates a firewall rule set for the customer network that the customer is then-currently using. For example, a firewall rule set for local network 106A of recovery site 120 is activated. Customer users then log in to the data centers 170 in a secure manner, such as using SSL and a VPN, and use copies of applications that are hosted at the data centers. The collection phase described above continues to be performed, except that the activated applications in the data centers 170 are the source applications and different locations in the data centers are the targets.

Activation of an archived virtual machine image may be performed in automated steps as follows. Portal 142 receives a request to activate a virtual machine from a customer or operator associated with service provider 140. Portal 142 passes the request to automation service 514, which determines that an automated restore is needed and provides the request to backup/restore module 524. Backup/restore module 524 calls a “find and activate vm” method and provides parameter values comprising a customer identifier and VM image identifier. In response, the method locates the VM image in storage based on the provided arguments, extracts the VM image from its current location and places the image into a newly requested location, decompresses and installs the image, and instructs the operating system to execute the installed image's executable files. The method also passes a code indicating success or failure to service 514, which provides the code to portal 142 for presentation to the requesting user.

In an embodiment, a restoration operation may be handled manually in the following manner.

Portal 142 receives a request to activate a virtual machine from a customer or operator associated with service provider 140. Portal 142 passes the request to automation service 514, which determines that an automated restore is needed and provides the request to backup/restore module 524. Backup/restore module 524 calls a “find and activate vm” method and provides parameter values comprising a customer identifier and VM image identifier. In response, the method generates a work order for restoration and sends the work order to operations personnel by fax, electronic messaging, or other communications. Operations personnel locates the VM image in storage based on the provided arguments, provides commands to extract the VM image from its current location and places the image into a newly requested location, decompress and installs the image, and instructs the operating system to execute the installed image's executable files. The operator enters in a workflow system a code indicating success or failure. The workflow system provides the code to service 514, which provides the code to portal 142 for presentation to the requesting user.

In this arrangement, service provider 140 comprises a disaster recovery platform that is expandable, modular enough to tie into a variety of customer environments and data elements, and configured to automate the movement, security, usage, and operational aspects of disaster recovery while providing the reporting and security compliance data that customers need to measure conformance to a business-level SLA.

Additionally or alternatively, any of the functions described above for performance using program code or software elements may comprise manual steps. For example, code for scheduling may be implemented manually in whole or in part using reminder events that are created and stored in a desktop software calendar program. When the calendar program signals that an event has occurred, a user may log in to the management application, and initiate one or more tools or operations to perform collection, transmission, verification, storage, etc. In an embodiment, one or more of the manual steps may be embodied in a programmatic script that is used in an entirely automated process or in conjunction with other manual steps.

2.3 Portal, Services, and Functional Modules of Stackware

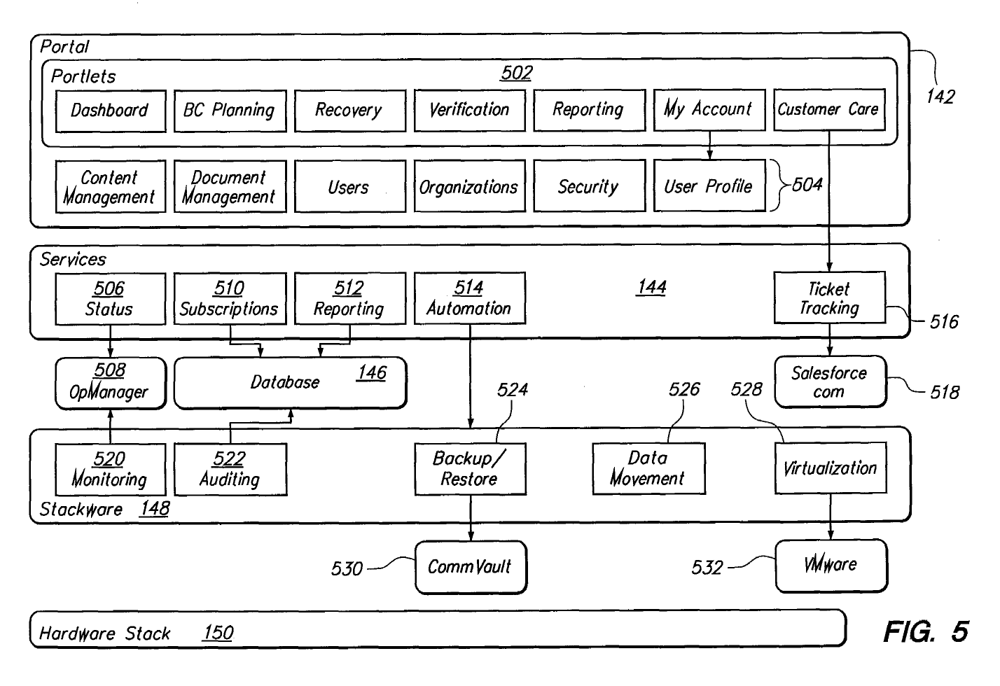

FIG. 5 illustrates an embodiment of the service provider in more detail. Portal 142 comprises one or more portlets 502 that implement discrete management functions. In an embodiment, each portlet 502 is a software module that may be added to or removed from portal 142 without affecting operation of other aspects of the portal. In an embodiment, portlets 502 provide a dashboard function, a business continuity planning function, a recovery function, a verification function, a reporting function, an account function, and a customer service function. In an embodiment, the dashboard function provides customer administrators with top-level access to other portal functions. The business continuity planning function may provide tools for reviewing a configuration of customer servers, applications and data to determine if everything that should be backed up is being backed up, and to evaluate other aspects of disaster preparedness. The recovery function enables a customer or an administrator of service provider 140 to initiate data recovery operations. The verification function enables a customer or an administrator of service provider 140 to initiate verification of data that has been collected from a customer site including accessing advanced verification functions. The reporting function provides access to reports about the status of collection, verification, storage and recovery. The account function enables customer access to billing information, contact details, and SLA terms. The customer service function enables a customer to initiate trouble reporting and enables an administrator of service provider 140 to monitor trouble issues.

Portal 142 may further comprise one or more embedded applications 504 that implement tasks such as content management, document management, user administration, organization administration, security management, and user profile management. Typically the embedded applications 504 are accessible only to an administrator of service provider 140.

In an embodiment, services 144 comprise a status service 506, subscriptions service 510, reporting service 512, automation service 514, and ticket tracking service 516. The status service 506 communicates with a network monitoring application 508, such as OpManager, to request information about the status of elements of data center 170 or hardware 150; received status information may be reported to any requesting element of portal 142 via an API that the services 144 exposes. The subscriptions service 510 manages subscriptions of applications or users to information in the database. For example, users, internal applications, external applications, or internal portlet elements may subscribe to receive notifications when certain information becomes available in the database. A publish-subscribe middleware layer is responsible for publishing data from the database to subscribers when the data enters the database. Examples of data that subscribers may have interest in includes data relating to SLAs and performance; success or completion of collection; status of other options; and notification that archiving was completed successfully. The reporting service 512 interfaces to a reporting portlet 502 and is coupled to database 146. Using information retrieved from database 146, the reporting service can generate report data about data collection operations, recovery operations, or other aspects of service provider 140. The automation service 514 interfaces the portal to scripts and other code to automatically perform operations such as data backup and data restore, and is coupled to a backup/restore module 524 of stackware 148. The ticket tracking service 516 is coupled to a customer care portlet 502 and to a ticket management system 518, such as salesforce.com.

In an embodiment, stackware 148 comprises a monitoring module 520 that is coupled to the network monitoring application 508. In this arrangement, monitoring module 520 can obtain information about network faults or status of network elements from the network monitoring application 508 and can use such information to affect the operation of other modules. Monitoring module 520 may implement a simple network management protocol (SNMP) agent that can issue SNMP queries for managed information bases (MIBs) on network elements, parse received MIB data, and update OpManager with received MIB data. Scripts may be used to automate operations of monitoring module 520. In an embodiment, stackware 148 comprises an auditing module 522 that is coupled to database 146 for the purpose of providing audit trail data to the database for storage. Audit trail data may come from backup/restore module 524, data movement module 526, or virtualization module 528. Audit trail data may comprise a host-by-host listing of movement of data in transmission, storage, and restoration operations to facilitate auditing compliance with SLA terms, confidentiality or privacy regulations, for example.

The backup/restore module 524 is coupled to automation service 514 and to a backup-restore application 530, such as CommVault. In an embodiment, backup/restore module 524 is configured to perform backup operations with local storage in CPE Servers 114, backup and restore operations with data centers 170, and provides database adapters. The data movement module 526 is responsible for managing data collection, storage and archiving while performing network optimization and storage optimization. The virtualization module 528 is coupled to a virtualization application 532, such as VMWare, to implement conversion of customer servers from physical form to virtual form for storage, verification and testing.

Stackware 148 may further comprise other elements that act as further interfaces or “glueware” to connect to higher-layer services, portlets, or applications of portal 142. In an embodiment, glueware may comprise a job scheduler, policy engine, virtual machine warehouse, UUID generation for files, and an analytics audit client. These elements support providing higher-level business continuity functions that can use stackware components so that the underlying implementation details do not introduce dependencies at the higher level. Further, security policies can be implemented in the glueware, using the lower-level security characteristics of each stackware element, and configuring them together to provide multi-tenant security as well as management simplicity because policy can be applied at the glueware level without directly interacting with the stackware elements.

2.4 Failure Scenarios

For clarity, examples herein are described in the context of recovery or restoration of servers, applications and/or data when a disaster occurs. However, various embodiments may be used in circumstances other than those that are conventionally considered a disaster. For example, recovery or restoration may be performed when a particular customer server, application or data is unavailable for reasons other than disaster. Thus, embodiments are not limited to use in the disaster recovery context.

In still another alternative, if the active site 102 suffers a disaster that does not require abandonment of the active site, such as a security breach, loss of data, storage failure, CPU failure, etc., then in a recovery operation, operational copies of the backed up applications 110 and data 112 may be moved to computer servers 108 and used at the active site. Thus, moving to a recovery site 120 is optional according to the circumstances.

Further, embodiments are useful in a variety of failure scenarios. Examples include a micro-failure, a critical failure and a test scenario. In each of these scenarios, embodiments uniquely provide securely shared areas or “sandboxes” for applications and data that enable safely performing recovery or testing recovery capability without harming customer applications or data. A micro-failure may comprise, for example, accidental deletion of the only copy of an important customer file, for which the customer does not have a local backup, but which was previously collected, transmitted, verified, and stored in data centers 170. Recovering from a micro-failure may involve performing a simple restore operation involving selecting an image, copying the image to CPE Server 114, performing verification, inflating and starting the image on the CPE Server for test purposes, shutting down the image, and copying the inflated image to customer storage for active use. Alternatively, responding to a micro-failure may comprise temporarily turning on a virtual server that is hosted in data centers 170 and accessible to user stations 104 over network 130. This approach may be appropriate to provide backup or redundancy for important servers of a customer for which the customer does not have a local backup server.

A critical failure may comprise a situation in which the active site 102 has lost the capability to do all or most data processing, and the owner or operator or active site needs the service provider 140 to act as a proxy data processor for all or some of the site's data processing functions. Typically a critical failure will require the service provider to host servers, applications and data for time periods on the order of 2-5 days, although shorter or longer durations are possible. Generally, such hosting involves providing for execution of application software or servers using the most current image as described herein with respect to the recovery phase. In a critical failure, service provider 140 continues to perform collection of customer data, but the source of collected data is the recovered applications, servers or data operating at data centers 170.

In a third scenario, the service provider 140 may work in a test capacity to provide the customer with an exercise of the ability to recover from a disaster. In a test capacity, one or more servers in data centers 170 are used for test purposes and applications, servers and data can be moved to the test servers, inflated, tested, and used without risk of damage to production data of the customer. This approach enables a customer to perform a business continuity analysis by testing its ability to recover from a true disaster. Further, a customer may use remotely hosted, inflated images of servers and applications at data centers 170 as a test platform to determine, for example, the impact of a server upgrade or application upgrade, without affecting production operations at the active site 102. Thus, the data centers 170 become a sandbox site for that purpose.

Restoration in response to any of the foregoing failure scenarios may relate to any of entire server images, application images, entire datasets, or units of information at any level of granularity that is represented in a source file system, server, or computer. For example, because database 146 reflects names of individual files rather than opaque archives, as well as images and other units of information, a subsequent restoration operation may target an individual file rather than the entire archive. User input may be received as part of a restoration request that specifies a unit of information such as a file, an individual database table, one or more rows or columns of specified database tables, messages within message archives, calendars or other sub-applications within a unified information application, or other units of information.

For purposes of illustrating clear examples, embodiments herein have been described in connection with certain automated steps that may be performed by programmatic scripts, software code loaded into a general-purpose programmable computer, or other automated elements. Other embodiments may use one or manual steps in addition to or as alternatives to the steps that are described as automated. The intent of the disclosure is to describe a system that is automated to the extent possible or practical, but to encompass equivalent systems, methods, and techniques in which manual steps are used additionally or alternatively to accomplish the functions described herein and recited in the claims.

3.0 Implementation Example—Hardware Overview

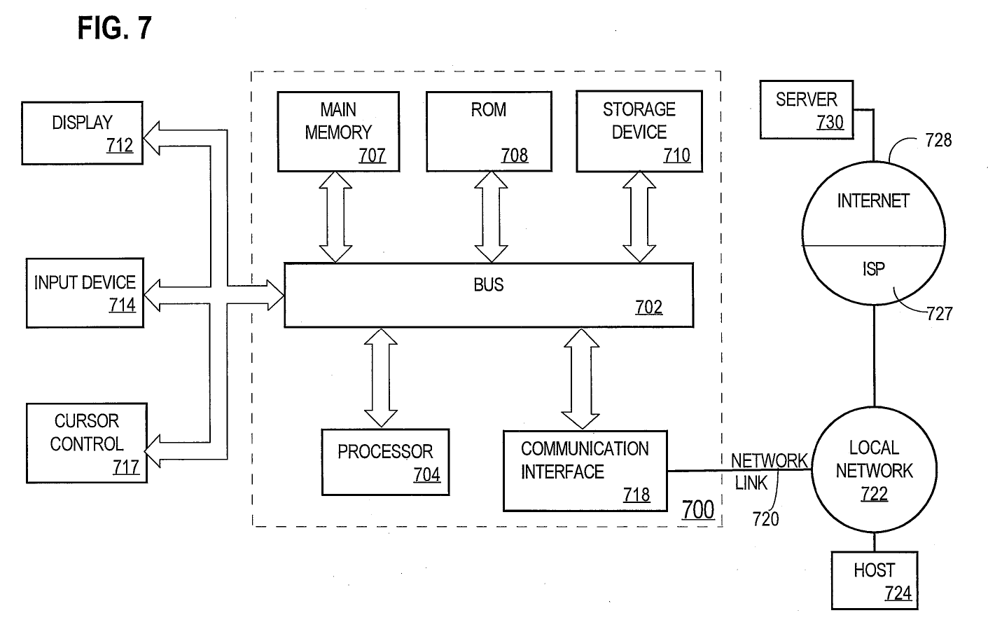

FIG. 7 is a block diagram that illustrates a computer system 700 upon which an embodiment of the invention may be implemented. Computer system 700 includes a bus 702 or other communication mechanism for communicating information, and a processor 704 coupled with bus 702 for processing information. Computer system 700 also includes a main memory 706, such as a random access memory (RAM) or other dynamic storage device, coupled to bus 702 for storing information and instructions to be executed by processor 704. Main memory 706 also may be used for storing temporary variables or other intermediate information during execution of instructions to be executed by processor 704. Computer system 700 further includes a read only memory (ROM) 708 or other static storage device coupled to bus 702 for storing static information and instructions for processor 704. A storage device 710, such as a magnetic disk or optical disk, is provided and coupled to bus 702 for storing information and instructions.

Computer system 700 may be coupled via bus 702 to a display 712, such as a cathode ray tube (CRT), for displaying information to a computer user. An input device 714, including alphanumeric and other keys, is coupled to bus 702 for communicating information and command selections to processor 704. Another type of user input device is cursor control 716, such as a mouse, a trackball, or cursor direction keys for communicating direction information and command selections to processor 704 and for controlling cursor movement on display 712. This input device typically has two degrees of freedom in two axes, a first axis (e.g., x) and a second axis (e.g., y), that allows the device to specify positions in a plane.

The invention is related to the use of computer system 700 for implementing the techniques described herein. According to one embodiment of the invention, those techniques are performed by computer system 700 in response to processor 704 executing one or more sequences of one or more instructions contained in main memory 706. Such instructions may be read into main memory 706 from another machine-readable medium, such as storage device 710. Execution of the sequences of instructions contained in main memory 706 causes processor 704 to perform the process steps described herein. In alternative embodiments, hard-wired circuitry may be used in place of or in combination with software instructions to implement the invention. Thus, embodiments of the invention are not limited to any specific combination of hardware circuitry and software.

The term “machine-readable medium” as used herein refers to any medium that participates in providing data that causes a machine to operation in a specific fashion. In an embodiment implemented using computer system 700, various machine-readable media are involved, for example, in providing instructions to processor 704 for execution. Such a medium may take many forms, including but not limited to storage media and transmission media. Storage media includes both non-volatile media and volatile media. Non-volatile media includes, for example, optical or magnetic disks, such as storage device 710. Volatile media includes dynamic memory, such as main memory 706. Transmission media includes coaxial cables, copper wire and fiber optics, including the wires that comprise bus 702. Transmission media can also take the form of acoustic or light waves, such as those generated during radio-wave and infra-red data communications. All such media must be tangible to enable the instructions carried by the media to be detected by a physical mechanism that reads the instructions into a machine.

Common forms of machine-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 704 for execution. For example, the instructions may initially be carried on a magnetic disk of a remote computer. The remote computer can load the instructions into its dynamic memory and send the instructions over a telephone line using a modem. A modem local to computer system 700 can receive the data on the telephone line and use an infra-red transmitter to convert the data to an infra-red signal. An infra-red detector can receive the data carried in the infra-red signal and appropriate circuitry can place the data on bus 702. Bus 702 carries the data to main memory 706, from which processor 704 retrieves and executes the instructions. The instructions received by main memory 706 may optionally be stored on storage device 710 either before or after execution by processor 704.

Computer system 700 also includes a communication interface 718 coupled to bus 702. Communication interface 718 provides a two-way data communication coupling to a network link 720 that is connected to a local network 722. For example, communication interface 718 may be an integrated services digital network (ISDN) card or a modem to provide a data communication connection to a corresponding type of telephone line. As another example, communication interface 718 may be a local area network (LAN) card to provide a data communication connection to a compatible LAN. Wireless links may also be implemented. In any such implementation, communication interface 718 sends and receives electrical, electromagnetic or optical signals that carry digital data streams representing various types of information.

Network link 720 typically provides data communication through one or more networks to other data devices. For example, network link 720 may provide a connection through local network 722 to a host computer 724 or to data equipment operated by an Internet Service Provider (ISP) 726. ISP 726 in turn provides data communication services through the world wide packet data communication network now commonly referred to as the “Internet” 728. Local network 722 and Internet 728 both use electrical, electromagnetic or optical signals that carry digital data streams. The signals through the various networks and the signals on network link 720 and through communication interface 718, which carry the digital data to and from computer system 700, are exemplary forms of carrier waves transporting the information.

Computer system 700 can send messages and receive data, including program code, through the network(s), network link 720 and communication interface 718. In the Internet example, a server 730 might transmit a requested code for an application program through Internet 728, ISP 726, local network 722 and communication interface 718.

The received code may be executed by processor 704 as it is received, and/or stored in storage device 710, or other non-volatile storage for later execution. In this manner, computer system 700 may obtain application code in the form of a carrier wave.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A data processing system, comprising:
one or more data storage and compute units that are configured to be coupled to a plurality of active sites, wherein each of the data storage and compute units is configured to cause collection of one or more copies of one or more servers, applications or data of the active sites, wherein each of the data storage and compute units is configured to receive transmissions of the copies of the servers, applications and data, to verify the copies, and to store the copies in online accessible secure storage that is segregated by business entity associated with each of the active sites;
logic stored in a computer-readable storage medium and coupled to the data storage and compute units, wherein the logic is operable to receive a request from a particular active site to restore one or more data elements contained in the secure storage of the data storage and compute unit associated with the particular active site, to inflate the one or more data elements, and to provide the particular active site with online access to the one or more data elements that are inflated.

2. The system of claim 1, wherein the data elements comprise virtual machine images of the servers, applications and data.

3. The system of claim 1, wherein the data elements comprise any of files, tables, and messages within any of the copies of servers, applications and data that are stored in the secure online accessible storage.

4. The system of claim 1, wherein the logic comprises one or more glueware modules that implement the functions of collection, storing, verification, restoring, activating, and providing in cooperation with one or more stackware modules that implement low-level logical functions in communication with lower-level hardware and software elements and that are configured for modification in response to changes in the lower-level hardware and software elements without affecting the functions of the glueware.

5. The system of claim 1, wherein the logic further comprises a management interface operable to display information about all the copies of the servers, applications and data that are stored in the secure online accessible storage for all of the active sites, wherein the management interface is configured with functions to manage the particular active site, a particular one of the business entities, and all the active sites.

6. The system of claim 1, wherein the logic is further operable to copy the one or more data elements to a recovery site that is identified in the request, to inflate the one or more data elements at the recovery site, and to provide the particular active site with access to the one or more data elements that are inflated.

7. The system of claim 1, wherein each of the data storage and compute units is configured to receive transmissions of the copies of the servers, applications and data, to store the copies in a demilitarized zone (DMZ) storage tier, to verify the copies in the DMZ storage tier, and to store the copies in the online accessible secure storage that is segregated by business entity.

8. The system of claim 1, wherein each of the one or more data centers comprises a datacenter wide area network data deduplication unit, a secure remote network connectivity unit, a datacenter inbound network routing unit, a datacenter perimeter security unit, a datacenter LAN segmentation unit, an incoming verification server, and a script processor configured with one or more automated scripts for processing the copies that are received from the CPE servers.

9. The system of claim 1, wherein a data center is configured to receive transmissions of the copies of the servers, applications and data for all the active sites and all the business entities, to store the copies in a demilitarized zone (DMZ) storage tier of the data center with secure segregation of the copies associated with different business entities, to verify the copies in the DMZ storage tier, to store the copies in the online accessible secure storage of the data center with secure segregation of the copies associated with different business entities, and to concurrently move one or more other instances of the copies from the online accessible secure storage to archival storage of the data center with secure segregation of the copies associated with different business entities.

10. A data processing method, comprising:
at a plurality of customer premises equipment (CPE) servers located at a plurality of different active sites, each of the CPE servers comprising a local storage unit, collecting one or more copies of one or more servers, applications or data of the active site at which that CPE server is located and storing the copies in the local storage unit of that CPE server;
at one or more data centers each comprising a data storage and compute unit that is coupled to the CPE servers through a network, receiving transmissions of the copies of the servers, applications and data, to verify the copies, and storing the copies in online accessible secure storage that is segregated by business entity;
receiving, a request from a particular active site to restore one or more data elements contained in the secure storage of the data storage and compute unit associated with the particular active site;
activating the one or more data elements; and
providing the particular active site with online access to the one or more data elements that are inflated.

11. The method of claim 10, wherein each of the CPE servers is located at a different business entity.

12. The method of claim 10, wherein the data elements comprise any of files, tables, and messages within any of the copies of servers, applications and data that are stored in the secure online accessible storage.

13. The method of claim 10, further comprising generating a management interface that displays information about all the copies of the servers, applications and data that are stored in the secure online accessible storage for all of the active sites.

14. The method of claim 10, further comprising copying the one or more data elements to a recovery site that is identified in the request, activating the one or more data elements at the recovery site, and providing the particular active site with access to the one or more data elements that are inflated.

15. The method of claim 10, further comprising, at the data storage and compute unit, receiving transmissions of the copies of the servers, applications and data, storing the copies in a demilitarized zone (DMZ) storage tier, validating the copies in the DMZ storage tier, and storing the copies in the online accessible secure storage that is segregated by business entity only after verification in the DMZ storage tier.

16. The method of claim 10, further comprising:
receiving a request from a particular active site to restore one or more data elements contained in the secure storage of the data storage and compute unit associated with the particular active site;
determining that a network connection of the CPE server for the particular active site to the data storage and compute unit is unavailable;
activating the one or more data elements using the copies in the local storage unit of that CPE server; and
providing the particular active site with access to the one or more data elements that are inflated.

17. A data processing system, comprising:
a plurality of customer premises equipment (CPE) servers located at a plurality of different active sites, each of the CPE servers comprising a local storage unit, wherein each of the CPE servers is configured to collect one or more copies of one or more servers, applications or data of the active site at which that CPE server is located and to store the copies in the local storage unit of that CPE server;
a data storage and compute unit that is coupled to the CPE servers through a network, wherein the data storage and compute unit is configured to receive transmissions of the copies of the servers, applications and data, to verify the copies, and to store the copies in online accessible secure storage that is segregated by business entity;
logic stored in a computer-readable storage medium and coupled to the data storage and compute unit and to the CPE servers through the network, wherein the logic is operable to receive a request from a particular active site to restore one or more data elements contained in the secure storage of the data storage and compute unit associated with the particular active site, to inflate the one or more data elements, and to provide the particular active site with online access to the one or more data elements that are inflated.

18. The system of claim 17, wherein each of the CPE servers is located at a different business entity.

19. The system of claim 17, wherein the logic is further operable to:
receive a request from a particular active site to restore one or more data elements contained in the secure storage of the data storage and compute unit associated with the particular active site;
determine that a network connection of the CPE server for the particular active site to the data storage and compute unit is unavailable;
inflate the one or more data elements using the copies in the local storage unit of that CPE server; and
provide the particular active site with access to the one or more data elements that are inflated.

20. The system of claim 17, wherein each CPE server comprises a virtual image capture unit configured to convert physical servers or pre-existing virtual servers of the active site in which that CPE server is located to one or more virtual images.

21. The system of claim 20, wherein each CPE server further comprises a remote wide area network (WAN) optimization unit configured to de-duplicate data that is transmitted from the CPE server to the one or more data centers.

22. The system of claim 1, wherein each of the data storage and compute units is further configured to cause storing the copies in on-site storage of the active sites.
